(19) United States
(12) Patent Application Publication
(10) Pub. No.: US 2025/0374033 A1
(43) Pub. Date: Dec. 4, 2025

(54) SYSTEM AND METHOD FOR WIRELESS COMMUNICATIONS IN LOW-CAPABILITY MODE

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US); Rui Cao, Sunnyvale, CA (US); Ken Kinwah Ho, San Jose, CA (US); Po Wei Tan, San Jose, CA (US)

(21) Appl. No.: 19/220,924

(22) Filed: May 28, 2025

Related U.S. Application Data
(60) Provisional application No. 63/652,410, filed on May 28, 2024.
(60) Provisional application No. 63/708,622, filed on Oct. 17, 2024.

(51) Int. Cl. H04W 8/22; H04L 1/00; H04W 74/00; H04W 74/0816; H04W 84/12

(52) U.S. Cl. CPC H04W 8/22; H04L 1/0003; H04W 74/002; H04W 74/0816; H04W 84/12

(57) ABSTRACT

Embodiments of a method and apparatus for wireless communications are disclosed. In an embodiment, a wireless device includes a controller configured to generate an announcement regarding whether the wireless device is capable of receiving a frame other than an initial control frame when the wireless device operates in a low-capability mode and a wireless transceiver configured to transmit the announcement to a second wireless device.

### CROSS-REFERENCE TO RELATED APPLICATIONS

This application is entitled to the benefit of U.S. Provisional Patent Application Ser. No. 63/652,410, filed on May 28, 2024, and U.S. Provisional Patent Application Ser. No. 63/708,622, filed on Oct. 17, 2024, the contents of which are incorporated by reference herein.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD (STA MLD) through one or more wireless communications links. Some applications, for example, video teleconferencing, streaming entertainment, high definition (HD) video surveillance applications, outdoor video sharing applications, etc., require relatively high system throughput. Wireless devices may operate in different capability modes with different capabilities.

### SUMMARY

Embodiments of a method and apparatus for wireless communications are disclosed. In an embodiment, a wireless device includes a controller configured to generate an announcement regarding whether the wireless device is capable of receiving a frame other than an initial control frame when the wireless device operates in a low-capability mode and a wireless transceiver configured to transmit the announcement to a second wireless device. Other embodiments are also disclosed.

In an embodiment, the controller is further configured to generate the announcement regarding whether the wireless device is capable of receiving a management or data frame other than the initial control frame when the wireless device operates in the low-capability mode.

In an embodiment, the controller is further configured to generate the announcement regarding whether the wireless device is capable of receiving the frame in a PPDU other than a non-High throughput (HT) duplicate PPDU.

In an embodiment, the PPDU other than the non-HT duplicate PPDU is one of a HT PPDU, a Very High Throughput (VHT) PPDU, a High Efficiency (HE) PPDU, an Extremely High Throughput (EHT) PPDU, and an Ultra High Reliability (UHR) PPDU.

In an embodiment, the second wireless device transmits a management or data frame to the wireless device operating in the low-capability mode unless the second wireless device intends to perform frame exchanges with the wireless device in a high-capability mode, in which case the second wireless device transmits the initial control frame to the wireless device for the wireless device's switch from the low-capability mode to the high-capability mode.

In an embodiment, when the wireless device is not capable of receiving the frame other than the initial control frame when the wireless device operates in the low-capability mode, the second wireless device instructs the wireless device to switch from the low-capability mode to a full-capability mode for a management or data frame reception.

In an embodiment, the wireless transceiver is further configured to receive the frame contained in a non-High throughput (HT) Physical Layer Protocol Data Unit (PPDU), a Very High Throughput (VHT) PPDU, a High Efficiency (HE) PPDU, an Extremely High Throughput (EHT) PPDU, or an Ultra High Reliability (UHR) PPDU after the initial control frame is received.

In an embodiment, the initial control frame in a transmit opportunity (TXOP) indicates a receiver bandwidth, a number of spatial streams (NSS), and modulation coding scheme (MCS) information of the wireless device operating in the low-capability mode for subsequent frame exchanges in the TXOP.

In an embodiment, the wireless transceiver is further configured to receive the frame using the receiver bandwidth, the NSS, and the MCS information.

In an embodiment, the controller is further configured to generate a frame that includes the announcement, and the wireless transceiver is further configured to transmit the frame to the second wireless device.

In an embodiment, the announcement is contained in an Ultra High Reliability (UHR) capabilities element of the frame.

In an embodiment, the second wireless device includes a wireless access point (AP), and the wireless device includes a wireless non-AP station (STA) associated with the wireless AP.

In an embodiment, the second wireless device is a transmit opportunity (TXOP) holder, and the wireless device is a TXOP responder.

In an embodiment, the wireless device is compatible with an Institute of Electrical and Electronics Engineers (IEEE) 802.11 protocol.

In an embodiment, the wireless device includes a first wireless multi-link device (MLD), the second wireless device includes a second wireless MLD, and the first wireless MLD are linked to the second wireless MLD through wireless links.

In an embodiment, a method for wireless communication involves at a first wireless device, generating an announcement regarding whether the first wireless device is capable of receiving a frame other than an initial control frame when the first wireless device operates in a low-capability mode and from the first wireless device, transmitting the announcement to a second wireless device.

In an embodiment, the frame includes a management or data frame.

In an embodiment, at the first wireless device, generating the announcement regarding whether the first wireless device is capable of receiving the frame other than the initial control frame when the first wireless device operates in the low-capability mode includes at the first wireless device, generating the announcement regarding whether the wireless device is capable of receiving the frame in a PPDU other than a non-High throughput (HT) duplicate PPDU.

In an embodiment, the PPDU other than the non-HT duplicate PPDU is one of a HT PPDU, a Very High Throughput (VHT) PPDU, a High Efficiency (HE) PPDU, an Extremely High Throughput (EHT) PPDU, and an Ultra High Reliability (UHR) PPDU.

In an embodiment, the method further includes from the second wireless device, transmitting a management or data frame to the first wireless device operating in the low-capability mode unless the second wireless device intends to perform frame exchanges with the first wireless device in a high-capability mode, in which case the second wireless device transmits the initial control frame to the first wireless device for the first wireless device's switch from the low-capability mode to the high-capability mode.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 depicts a state diagram that includes a dynamic power save (DPS) mode being enabled and a DPS mode being disabled in accordance with an embodiment of the invention.

FIG. 5 illustrates a frame format in accordance with an embodiment of the invention.

FIG. 6 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

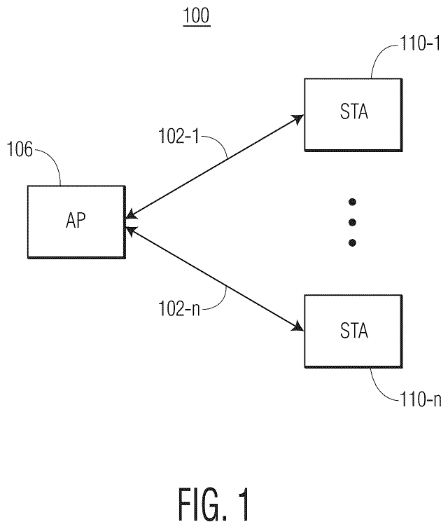

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system can include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 is affiliated with an AP MLD, and a STA 100-j with j being an integer equal to one of 1 to n with n being an integer is affiliated with a STA MLD j (=non-AP MLD j).

In the embodiment depicted in FIG. 1, the AP 106 can be implemented in hardware (e.g., circuits), software, firmware, or a combination thereof. The AP 106 can be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. In some embodiments, the controller is configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 include multiple APs. In these embodiments, each of the APs of the wireless communications system 100 can operate in a different frequency band. For example, one AP can operate in a 2.4 gigahertz (GHz) frequency band and another AP can operate in a 5 GHz frequency band.

In the embodiment depicted in FIG. 1, each of the at least one STA 110-1, . . . , 110-n can be implemented in hardware (e.g., circuits), software, firmware, or a combination thereof. The STA 110-1, . . . , or 110-n can be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. In some embodiments, the controller is configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). In some embodiments, an MPDU includes a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) transmits data to at least one associated station (STA) MLD (non-AP MLD). In some embodiments, the AP MLD is configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

Wireless devices may operate in different capability states with different capabilities. For example, in a low-capability state, a wireless device may detect medium busy/idle and/or receive initial control frame and broadcast frames, and in a high-capability state, the wireless device may execute frame exchanges with high capabilities (e.g., high MAC, >1 Service Set (SS), and/or wider bandwidth (BW)). A wireless device can switch between a low-capability state and a high-capability state. For example, a wireless device can switch between a low-capability state of a low-capability mode and a high-capability state of the low-capability mode.

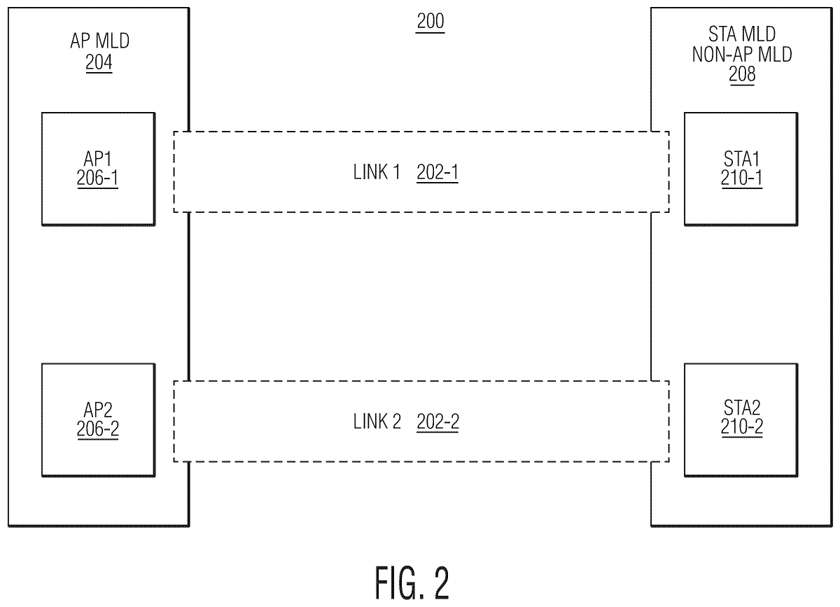

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system is a wireless communications system, such as a wireless communications system compatible with an IEEE 802.11 protocol. For example, the multi-link communications system is a wireless communications system compatible with an IEEE 802.11bn protocol. Although the depicted multi-link communications system 200 is shown in FIG. 2 with certain components and described with certain functionality herein, other embodiments of the multi-link communications system includes fewer or more components to implement the same, less, or more functionality. For example, in some embodiments, the multi-link communications system includes a single AP MLD and multiple STA MLDs, or multiple AP MLDs and more than one STA MLD. In some embodiments, the legacy STAs (non-EHT STAs) associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 can be implemented in hardware (e.g., circuits), software, firmware, or a combination thereof. The APs 206-1 and 206-2 can be fully or partially implemented as an integrated circuit (IC) device. In some embodiments, the APs 206-1 and 206-2 are wireless APs compatible with at least one WLAN communications protocol (e.g., at least one IEEE 802.11 protocol). For example, the APs 206-1 and 206-2 are wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. In some embodiments, the at least one controller is configured to control the at least one transceiver to process transmitted/received packets through the at least one antenna. In some embodiments, the at least one controller is implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 operates in a different BSS operating channel. For example, AP1 206-1 operates in a 320 MHz (one million hertz) BSS operating channel at 6 Gigahertz (GHz) band and AP2 206-2 operates in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 can be implemented in hardware (e.g., circuits), software, firmware, or a combination thereof. The STAs 210-1 and 210-2 can be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 is implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 operates in a different frequency band or the same frequency band. For example, the non-AP STA 210-1 operates in the 2.4 GHz frequency band and the non-AP STA 210-2 operates in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. In some embodiments, the at least one controller is configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) includes a BSS operating channel established by an AP (e.g., AP1 206-1 or AP2 206-2) that features multiple 20 MHz channels used to transmit frames (e.g., beacon frames, management frames other than Beacon, Data frames, control frames etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel is a punctured 20 MHz channel or an unpunctured 20 MHz channel. Although the STA MLD 208 is shown in FIG. 2 as including two non-AP STAs, other embodiments of the STA MLD 208 include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), transmits MLD-level management frames in a multi-link operation with a second MLD, e.g., STA MLD or AP MLD, to coordinate the multi-link operation between the first MLD and the second MLD. As an example, a management frame may be a Traffic Identifier (TID)-to-link mapping negotiation frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD transmits link-level management frames to a STA/AP of a second MLD. In some embodiments, one or more link-level management frames are transmitted via a cross-link transmission (e.g., according to an IEEE 802.11bn communication protocol). As an example, a cross-link management frame transmission involves a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame is transmitted between a first MLD and a second MLD on any link (e.g., at least one of two links or at least one of multiple links) associated with the first MLD and the second MLD.

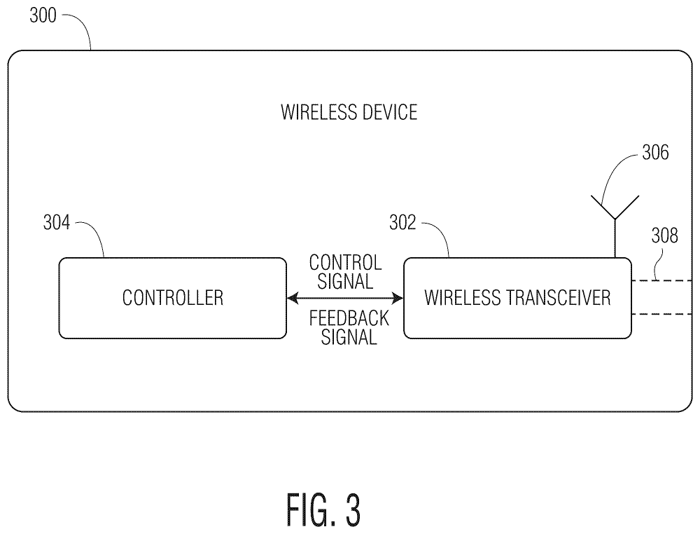

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 includes at least one optional network port 308 operably connected to the wireless transceiver. In some embodiments, the wireless transceiver includes a physical layer (PHY) device. The wireless transceiver can be any suitable type of wireless transceiver. For example, the wireless transceiver is a LAN transceiver (e.g., a transceiver compatible with an IEEE 802.11 protocol). In some embodiments, the wireless device 300 includes multiple transceivers. In some embodiments, the controller is configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna can be any suitable type of antenna. For example, the antenna is an induction type antenna such as a loop antenna or any other suitable type of induction type antenna. However, the antenna is not limited to an induction type antenna. The network port can be any suitable type of port.

The wireless device 300 can operate in different capability states with different capabilities. For example, a low-capability state includes a medium listening state that detects medium busy/idle, receives initial control frame, and a high-capability state includes a frame exchange state that executes frame exchanges with high capabilities (e.g., high MAC, >1 Service Set (SS), and/or wider bandwidth (BW)).

In some implementations, a STA/AP may be in a low-capability state or mode where a peer device transmits an initial control frame (e.g., a multi-user-request to send (MU-RTS) or Buffer Status Report Poll (BSRP) Trigger frame) to soliciting STA's high-capability mode for the frame exchanges. A mobile AP may announce whether it needs the initial control frame exchange to receive the frames other than the initial control frame for the probing, association, key negotiation, data frame exchanges. A STA in low-capability listening mode may receive a short data/management frame other than initial control frame without the initial control frame exchange. However, some STAs in low-capability listening mode is not capable of receiving frames other than the initial control frame. In addition, there may be a requirement for a STA/AP in low-capability listening mode to optimize its short frame reception.

In accordance with an embodiment of the invention, a STA (also referred to as a non-AP STA) or an AP announces whether it is capable of receiving a frame other than an initial control frame (ICF) if the STA is in a low-capability mode. In some embodiments, the controller 304 is configured to generate an announcement regarding whether the wireless device 300 is capable of receiving a frame other than an initial control frame (ICF) when the wireless device 300 operates in a low-capability mode, and the wireless transceiver 302 is configured to transmit the announcement to a second wireless device, for example, through the at least one antenna 306. In some embodiments, the controller 304 is further configured to generate the announcement regarding whether the wireless device 300 is capable of receiving the frame (e.g., a management or data frame) other than the initial control frame (e.g., in a bandwidth wider than) when the wireless device operates in the low-capability mode. In some embodiments, when the wireless device 300 is capable of receiving the frame (e.g., a management or data frame) other than the initial control frame when the wireless device 300 operates in the low-capability mode, the second wireless device transmits a management or data frame to the wireless device operating in the low-capability mode. In some embodiments, the time of the management or data frame and its acknowledgement is shorter than the time of the initial control frame, the responding control frame, the short data frame and the acknowledgement of the management/data frame. In some embodiments, the controller is further configured to generate the announcement regarding whether the wireless device is capable of receiving the frame in a PPDU other than a non-High throughput (HT) duplicate PPDU in the low-capability mode. In some embodiments, the PPDU other than the non-HT duplicate PPDU is one of a HT PPDU, a Very High Throughput (VHT) PPDU, a High Efficiency (HE) PPDU, an Extremely High Throughput (EHT) PPDU, and an Ultra High Reliability (UHR) PPDU. In some embodiments, the second wireless device transmits a management or data frame to the wireless device operating in the low-capability mode unless the second wireless device intends to perform frame exchanges with the wireless device in a high-capability mode, in which case the second wireless device transmits the initial control frame to the wireless device for the wireless device's switch from the low-capability mode to the high-capability mode. In some embodiments, when the wireless device 300 is not capable of receiving the frame other than the initial control frame when the wireless device operates in the low-capability mode, the second wireless device instructs the wireless device to switch from the low-capability mode to a full-capability mode for a management or data frame reception. In some embodiments, the wireless transceiver is further configured to receive the frame contained in a non-High throughput (HT) Physical Layer Protocol Data Unit (PPDU), a Very High Throughput (VHT) PPDU, a High Efficiency (HE) PPDU, an Extremely High Throughput (EHT) PPDU, or an Ultra High Reliability (UHR) PPDU after the initial control frame is received. In some embodiments, the initial control frame in a transmit opportunity (TXOP) indicates a receiver bandwidth, a number of spatial streams (NSS), and modulation coding scheme (MCS) information of the wireless device 300 operating in the low-capability mode for subsequent frame exchanges in the TXOP. In some embodiments, the wireless transceiver 302 is further configured to receive the frame using the receiver bandwidth, the NSS, and the MCS information, for example, through the at least one antenna 306. In some embodiments, the controller 304 is further configured to generate a frame that includes the announcement, and the wireless transceiver 302 is further configured to transmit the frame to the second wireless device. In some embodiments, the announcement is contained in an Ultra High Reliability (UHR) capabilities element of the frame. In some embodiments, the second wireless device includes a wireless access point (AP), and the wireless device 300 includes a wireless non-AP station (STA) associated with the wireless AP. In some embodiments, the second wireless device is a transmit opportunity (TXOP) holder, and the wireless device 300 is a TXOP responder. In some embodiments, the wireless device 300 is compatible with an Institute of Electrical and Electronics Engineers (IEEE) 802.11 protocol. In some embodiments, the wireless device includes a first wireless multi-link device (MLD), the second wireless device incudes a second wireless MLD, and the first wireless MLD are linked to the second wireless MLD through wireless links.

In some embodiments, the wireless device 300 is a mobile access point (AP) or a non-AP STA compatible with an Institute of Electrical and Electronics Engineers (IEEE) 802.11 protocol, the controller 304 is configured to generate an element that includes an announcement regarding whether the mobile AP or the non-AP STA is capable of receiving/transmitting a frame other than an initial control frame when the mobile AP or the non-AP STA operates in a low-capability mode, and the wireless transceiver 302 is configured to transmit the element to the non-AP stations (STAs) associated with the wireless AP to its associated AP respectively. In some embodiments, when the mobile AP or the non-AP STA is capable of receiving the frame other than the initial control frame when the mobile AP or non-AP STA operates in the low-capability mode, the non-AP STAs or the AP are allowed to transmit a management or data frame to the mobile AP or the non-AP STA operating in the low-capability mode. In some embodiments, when the mobile AP or the non-AP STA is not capable of receiving/transmitting the frame other than the initial control frame when the mobile AP or the non-AP STA operates in the low-capability mode, the non-AP STAs or the AP instruct the wireless AP or the non-AP STA respectively to switch from the low-capability mode to a full-capability mode for a management or data frame exchanges. In some embodiments, the discussion mentioned in this paragraph for a mobile AP is applied to a non-AP STA.

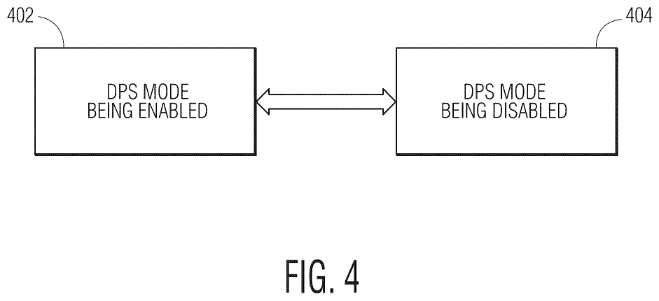

FIG. 4 depicts a state diagram that includes a dynamic power save (DPS) mode being enabled 402 and a dynamic power save mode being disabled (e.g., being always in a full-capability state) 404 in accordance with an embodiment of the invention. In the embodiment depicted in FIG. 4, a wireless device, which may be an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, and/or the wireless device 300 depicted in FIG. 3, can switch between operating in the DPS mode being enabled 402 and operating in the DPS mode being disabled 404. In some embodiments, a wireless device consumes less power in the DPS mode than in the DPS mode being disabled. In some embodiments, the DPS mode being enabled can switch/transition between a low-capability state and a high-capability state. In some embodiments, a wireless device consumes less power in the low-capability state than in the high-capability state.

Some implementations of frame type received in a low-capability mode, for example, by the wireless communications system 100 depicted in FIG. 1, the multi-link (ML) communications system 200 depicted in FIG. 2, and/or the wireless device 300 depicted in FIG. 3 are described as follows.

In some embodiments, a dynamic power save (DPS) AP/STA announces whether it in a low-capability (LC) mode is capable of receiving a frame other than an initial control frame (ICF) in its UHR Capabilities element or other element. In some embodiments, if/when the DPS AP/STA announces that it in a low-capability (LC) mode can receive (i.e., is capable of receiving) a frame other than the initial control frame, the peer device can transmit one or more Management and Data frames to the DPS AP/STA in the LC mode, and the DPS AP/STA is still in the LC mode after the Data/Management frame exchange. In some embodiments, if/when the DPS AP/STA announces that it in a low-capability (LC) mode cannot receive (i.e., is not capable of receiving) a frame other than the initial control frame, the peer device can transmit the ICF to the DPS AP/STA in the LC mode to switch to a full-capability mode for Management/Data frame reception/transmission.

In some embodiments, in a first option of received/transmitted PPDU formats in a low-capability (LC) mode (LCM), an AP in the LC mode can receive/transmit (i.e., is capable of receiving/transmitting) the frames that include an ICF in following PPDU: Non-HT (High Throughput) (duplicate) PPDU, HT PPDU, VHT PPDU, HE PPDU, EHT PPDU, UHR PPDU. In some embodiments, a non-AP STA in the LC mode can receive/transmit (i.e., is capable of receiving/transmit) the frames that include an ICF in following PPDU: Non-HT (duplicate) PPDU, HT PPDU, VHT PPDU, HE PPDU, EHT PPDU, UHR PPDU.

In some embodiments, in a second option of PPDU reception in an LCM, an AP in the LC mode can receive/transmit (i.e., is capable of receiving/transmitting) the frames that include an ICF in a Non-HT (duplicate) PPDU. In some embodiments, a non-AP STA in the LC mode can receive/transmit (i.e., is capable of receiving/transmitting) the frame that include an ICF in a Non-HT (duplicate) PPDU.

In some embodiments, in a third option of received/transmitted PPDU formats in an LCM, an AP in the LC mode can receive/transmit (i.e., is capable of receiving/transmitting) the frames other than an ICF in following PPDU: Non-HT (duplicate) PPDU with data rate 6, 12, 24 Mbps megabits per second, HE SU (single user) in MCS15 (MCS stands for Modulation Coding Scheme), EHT SU PPDU in MCS15, ELR (enhanced long range) PPDU with MCS 0. In some embodiments, an AP in the LC mode can receive/transmit (i.e., is capable of receiving/transmitting) an ICF in following PPDU: Non-HT (duplicate) PPDU with data rate 6, 12, 24 Mbps, ELR PPDU with MCS 0. In some embodiments, a non-AP STA in the LC mode can receive/transmit (i.e., is capable of receiving/transmitting) the frames other than an ICF in following PPDU: Non-HT (duplicate) PPDU with data rate 6, 12, 24 Mbps, HE SU PPDU in MCS15, EHT SU PPDU in MCS15, ELR PPDU with MCS 0. In some embodiments, a non-AP STA in the LC mode can receive/transmit (i.e., is capable of receiving/transmitting) an ICF in following PPDU: Non-HT (duplicate) PPDU with data rate 6, 12, 24 Mbps, ELR PPDU with MCS 0.

Some implementations of receiver (Rx) parameters of bandwidth (BW), N_{SS} (number of spatial streams), for example, by the wireless communications system 100 depicted in FIG. 1, the multi-link (ML) communications system 200 depicted in FIG. 2, and/or the wireless device 300 depicted in FIG. 3 are described as follows. In some embodiments, in an ICF of a TXOP, the peer device indicates the Rx bandwidth, N_{SS}, MCS of the TXOP responder in low-capability listening mode will use in the following frame exchanges of the TXOP. In some embodiments, the TXOP responder uses the bandwidth and N_{SS} to receive the following Management/Data frame.

Some implementations of frame length restriction, for example, by the wireless communications system 100 depicted in FIG. 1, the multi-link (ML) communications system 200 depicted in FIG. 2, and/or the wireless device 300 depicted in FIG. 3 are described as follows. In some embodiments, if/when the PPDU to carry a Data/Management frame under BW, MCS, N_{SS} is not longer than the time for the time for transmitter (Tx) PPDU for ICF+SIFS (Short Interframe Space)+the time for Tx PPDU for ICR (Initial Control Reply)+SIFS+the time for Tx the Data/Management frame in recipient's Rx BW, BW, MCS, N_{SS}, the Data/Management frame for a device in a low-capability mode can be transmitted without the preceding ICF+ICR (Initial Control Reply) frame exchange.

In some embodiments, a method of conducting frame exchanges for Data/Management frames between a first device and a second device includes announcing, by the first device in a low-capability listening mode, whether it needs to receive an ICF and transmit an ICR in order to receive a Management/Data frame, initiating, by the second device, frame exchanges of Management/Data frame differently based on whether the first device indicates whether it needs to receive the ICF and transmit the ICR in order to receive the Management/Data frame. In some embodiments, the second device transmits a short Management/Data frame without first transmitting the ICF if the first device indicates that it does not need to receive the ICF and transmit the ICR in order to receive the Management/Data frame. In some embodiments, if the first device indicates that it needs to receive the ICF and transmit the ICR in order to receive the Management/Data frame, the second device transmits the ICF to solicit ICR before conducting the other frame exchanges within the TXOP. In some embodiments, the ICF indicates the Rx BW and N_{SS} that the first device uses for the following frame reception.

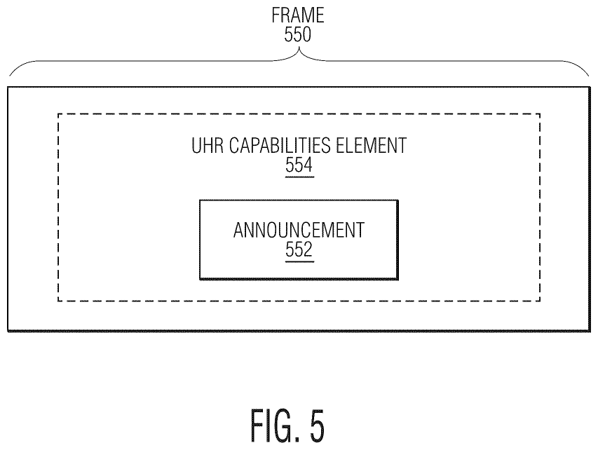

FIG. 5 illustrates a frame format 550 in accordance with an embodiment of the invention. The frame format 550 illustrated in FIG. 5 may be used by the wireless communications system 100 depicted in FIG. 1, the multi-link (ML) communications system 200 depicted in FIG. 2, and/or the wireless device 300 depicted in FIG. 3. In the embodiment depicted in FIG. 5, the frame format 550 includes an announcement 552 regarding whether a wireless device can enable or disable a peer device's low-capability mode. In some embodiments, the announcement 552 is contained in an Ultra High Reliability (UHR) capabilities element 554 of the frame 550. In some embodiments, the announcement 552 is contained in a Low-Capability Mode capabilities element (not shown in the figure) or other element.

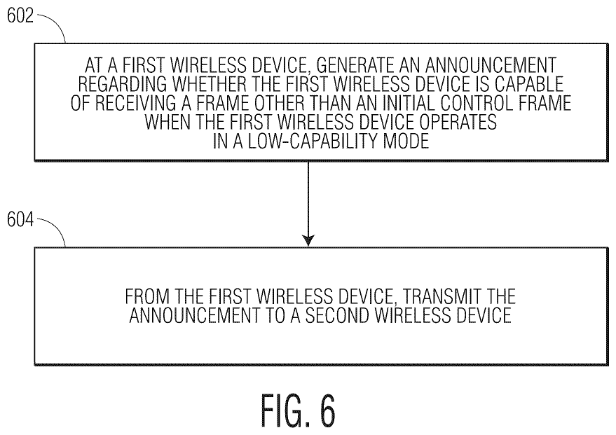

FIG. 6 is a process flow diagram of a method for wireless communications in accordance with an embodiment of the invention. At block 602, at a first wireless device, an announcement regarding whether the first wireless device is capable of receiving a frame other than an initial control frame when the first wireless device operates in a low-capability mode is generated. At block 604, from the first wireless device, the announcement is transmitted to a second wireless device. In some embodiments, the frame includes a management or data frame. In some embodiments, at the first wireless device, the announcement regarding whether the wireless device is capable of receiving the frame in a PPDU other than a non-High throughput (HT) duplicate PPDU is generated. In some embodiments, the PPDU other than the non-HT duplicate PPDU is one of a HT PPDU, a Very High Throughput (VHT) PPDU, a High Efficiency (HE) PPDU, an Extremely High Throughput (EHT) PPDU, and an Ultra High Reliability (UHR) PPDU. In some embodiments, from the second wireless device, a management or data frame is transmitted to the first wireless device operating in the low-capability mode unless the second wireless device intends to perform frame exchanges with the first wireless device in a high-capability mode, in which case the second wireless device transmits the initial control frame to the first wireless device for the first wireless device's switch from the low-capability mode to the high-capability mode. The first wireless device may be the same as or similar to an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, and/or the wireless device 300 depicted in FIG. 3. The second wireless device may be the same as or similar to an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to generate an announcement regarding whether the wireless device is capable of receiving a frame other than an initial control frame when the wireless device operates in a low-capability mode; and
a wireless transceiver configured to transmit the announcement to a second wireless device.

2. The wireless device of claim 1, wherein the controller is further configured to generate the announcement regarding whether the wireless device is capable of receiving a management or data frame other than the initial control frame when the wireless device operates in the low-capability mode.

3. The wireless device of claim 2, wherein the controller is further configured to generate the announcement regarding whether the wireless device is capable of receiving the frame in a Physical Layer Protocol Data Unit (PPDU) other than a non-High throughput (HT) duplicate PPDU.

4. The wireless device of claim 3, wherein the PPDU other than the non-HT duplicate PPDU is one of a HT PPDU, a Very High Throughput (VHT) PPDU, a High Efficiency (HE) PPDU, an Extremely High Throughput (EHT) PPDU, and an Ultra High Reliability (UHR) PPDU.

5. The wireless device of claim 1, wherein the second wireless device transmits a management or data frame to the wireless device operating in the low-capability mode unless the second wireless device intends to perform a plurality of frame exchanges with the wireless device in a high-capability mode, in which case the second wireless device transmits the initial control frame to the wireless device for the wireless device's switch from the low-capability mode to the high-capability mode.

6. The wireless device of claim 1, wherein when the wireless device is not capable of receiving the frame other than the initial control frame when the wireless device operates in the low-capability mode, the second wireless device instructs the wireless device to switch from the low-capability mode to a full-capability mode for a management or data frame reception.

7. The wireless device of claim 1, wherein the wireless transceiver is further configured to receive the frame contained in a non-High throughput (HT) Physical Layer Protocol Data Unit (PPDU), a Very High Throughput (VHT) PPDU, a High Efficiency (HE) PPDU, an Extremely High Throughput (EHT) PPDU, or an Ultra High Reliability (UHR) PPDU after the initial control frame is received.

8. The wireless device of claim 1, wherein the initial control frame in a transmit opportunity (TXOP) indicates a receiver bandwidth, a number of spatial streams (NSS), and modulation coding scheme (MCS) information of the wireless device operating in the low-capability mode for a plurality of subsequent frame exchanges in the TXOP.

9. The wireless device of claim 8, wherein the wireless transceiver is further configured to receive the frame using the receiver bandwidth, the NSS, and the MCS information.

10. The wireless device of claim 1, wherein the controller is further configured to generate a frame that comprises the announcement, and wherein the wireless transceiver is further configured to transmit the frame to the second wireless device.

11. The wireless device of claim 10, wherein the announcement is contained in an Ultra High Reliability (UHR) capabilities element of the frame.

12. The wireless device of claim 1, wherein the second wireless device comprises a wireless access point (AP), and wherein the wireless device comprises a wireless non-AP station (STA) associated with the wireless AP.

13. The wireless device of claim 1, wherein the second wireless device is a transmit opportunity (TXOP) holder, and wherein the wireless device is a TXOP responder.

14. The wireless device of claim 1, wherein the wireless device is compatible with an Institute of Electrical and Electronics Engineers (IEEE) 802.11 protocol.

15. The wireless device of claim 1, wherein the wireless device comprises a first wireless multi-link device (MLD), wherein the second wireless device comprises a second wireless MLD, and wherein the first wireless MLD are linked to the second wireless MLD through a plurality of wireless links.

16. A method for wireless communication, the method comprising:
at a first wireless device, generating an announcement regarding whether the first wireless device is capable of receiving a frame other than an initial control frame when the first wireless device operates in a low-capability mode; and
from the first wireless device, transmitting the announcement to a second wireless device.

17. The method of claim 16, wherein the frame comprises a management or data frame.

18. The method of claim 17, wherein at the first wireless device, generating the announcement regarding whether the first wireless device is capable of receiving the frame other than the initial control frame when the first wireless device operates in the low-capability mode comprises at the first wireless device, generating the announcement regarding whether the wireless device is capable of receiving the frame in a Physical Layer Protocol Data Unit (PPDU) other than a non-High throughput (HT) duplicate PPDU.

19. The method of claim 18, wherein the PPDU other than the non-HT duplicate PPDU is one of a HT PPDU, a Very High Throughput (VHT) PPDU, a High Efficiency (HE) PPDU, an Extremely High Throughput (EHT) PPDU, and an Ultra High Reliability (UHR) PPDU.

20. The method of claim 16, further comprising from the second wireless device, transmitting a management or data frame to the first wireless device operating in the low-capability mode unless the second wireless device intends to perform a plurality of frame exchanges with the first wireless device in a high-capability mode, in which case the second wireless device transmits the initial control frame to the first wireless device for the first wireless device's switch from the low-capability mode to the high-capability mode.
